(19) United States
(12) Patent Application Publication
(10) Pub. No.: US 2019/0126804 A1
(43) Pub. Date: May 2, 2019

(54) CUP HOLDER

(71) Applicant: LG INNOTEK CO., LTD., Seoul (KR)

(72) Inventors: Jong Bae SHIN, Seoul (KR); Jong Hyun KANG, Seoul (KR); Su Chan LIM, Seoul (KR); Seong Hyuk JEONG, Seoul (KR)

(21) Appl. No.: 16/301,480

(22) PCT Filed: May 20, 2016
(86) PCT No.: PCT/KR2016/005389

§ 371 Date: Nov. 14, 2018

(30) Foreign Application Priority Data
May 19, 2018 (KR) 10-2016-0061644

(51) Int. Cl. B60N 3/10; F25B 21/02

(52) U.S. Cl. CPC B60N 3/104; F25B 2321/023; F25B 2321/0251; F25B 21/02

(57) ABSTRACT

According to one embodiment, a cup holder is disclosed. The cup holder comprises: a holder body; a thermoelectric element disposed at a lower part of the holder body; a heat sink disposed at a lower part of the thermoelectric element; and a fan disposed on a side surface of the holder body, and discharging, through the heat sink, air suctioned from the side surface of the holder body.

### TECHNICAL FIELD

The present invention relates to a cup holder, and more specifically, to a heating and cooling cup holder.

### BACKGROUND ART

A cup holder mounted in a particular location such as a vehicle or the like can only serve to fix a cup to prevent spillage of the contents put in the cup due to movement and cannot heat or cool the contents put in a cup, a can, or the like.

Although a cup holder capable of performing heating and cooling has been developed to solve the problem of the cup holder, a cooling mode and a heating mode cannot be simultaneously performed.

Further, a cup holder using a thermoelectric element has been developed, but has a large volume due to a shape in which a fan is in contact with the thermoelectric element and a heat sink attached to the thermoelectric element. In addition, since a flow path space through which air introduced through the fan flows is large, the cup holder is difficult to compactly manufacture.

### DISCLOSURE

### Technical Problem

The present invention is directed to providing a hot and cold cup holder using a thermoelectric element.

### Technical Solution

A cup holder according to an embodiment of the present invention includes a holder body, a thermoelectric element disposed under the holder body, a heat sink disposed under the thermoelectric element, and a fan disposed at a side surface of the holder body and configured to discharge air suctioned from the side surface of the holder body through the heat sink.

The heat sink may include a plurality of fins disposed to be spaced apart from each other in a direction the same as a direction in which the air is discharged.

The plurality of fins may be disposed in parallel.

The cup holder may further include a guide part including a first member disposed between the holder body and the heat sink and including a hole and a second member disposed between the holder body and the fan and including an air flow path configured to guide the suctioned air.

The thermoelectric element may be disposed in the hole.

The air flow path may be formed such that the suctioned air passes toward the heat sink.

The fan may discharge the air in a direction different from a direction in which the air is suctioned.

The fan may include a blower fan.

The cup holder may further include a housing configured to surround outer surfaces of the heat sink and the fan.

The housing may include a suction port into which the air is suctioned from the fan and a discharge port through which the suctioned air is discharged.

The discharge port may be disposed to be adjacent to the heat sink.

The holder body may be made of a thermal conductive metal material.

The cup holder may further include a power module configured to supply power to the fan and the thermoelectric element.

The power module may be controlled so that the thermoelectric element may perform one of heating and cooling of the holder body.

The cup holder may further include a switch connected to the power module to transmit a control signal of one of the heating and the cooling of the holder body to the power module.

### Advantageous Effects

A cup holder according to an embodiment of the present invention can provide a heating and cooling function to a container configured to contain beverages using a heat absorption function or a heat generation function of a thermoelectric element. Particularly, the thermoelectric element can be disposed under the cup holder to uniformly provide the heating and cooling function to the whole parts of the container in the cup holder.

Further, a cup holder capable of easily receiving power regardless of a place and thus having improved portability and convenience can be provided.

In addition, a direction in which air flows in the cup holder and a structure of a heat sink attached to the thermoelectric element can correspond to each other to allow heat-exchange to occur efficiently, a cup holder having a slim structure can be implemented by varying disposition locations of the thermoelectric element and a fan, and space efficiency in the cup holder can be improved.

### DESCRIPTION OF DRAWINGS

FIG. 1 is a view illustrating a cup holder according to an embodiment of the present invention.

FIG. 2 is an exploded perspective view of the cup holder according to the embodiment of the present invention.

FIG. 3 is a cross-sectional view of the cup holder according to the embodiment of the present invention and an enlarged view of a heat sink.

FIG. 4 is a perspective view of the cup holder according to the embodiment of the present invention.

FIG. 5 is a side view of the cup holder according to the embodiment of the present invention.

FIG. 6 is a view illustrating various fans according to the embodiment of the present invention.

FIG. 7 is a cross-sectional view of a thermoelectric element according to the embodiment of the present invention.

FIG. 8 is a perspective view of the thermoelectric element according to the embodiment of the present invention.

FIG. 9 is a view illustrating a method of manufacturing thermoelectric legs having a lamination structure.

FIGS. 10 to 12 are conceptual diagrams of the heat sink according to the embodiment of the present invention.

### MODES OF THE INVENTION

Since the present invention may be variously changed and have various embodiments, particular embodiments will be exemplified in the drawings and described. However, the present invention is not limited to the particular embodiment and includes all changes, equivalents, and substitutes falling within the spirit and the scope of the present invention.

Further, it should be understood that, although the terms “first,” “second,” and the like may be used herein to describe various elements, the elements are not limited by the terms. The terms are only used to distinguish one element from another. For example, a first element could be termed a second element, and similarly, a second element could be termed a first element without departing from the scope of the present invention. The term “and/or” includes combinations of one or all of a plurality of associated listed items.

When predetermined components are mentioned to be “linked,” “coupled,” or “connected” to other components, the components may be directly linked or connected to other components, but it should be understood that additional components may be “linked,” “coupled,” or “connected” therebetween. However, when the predetermined components are mentioned to be “linked,” “coupled,” or “connected” to other components, it should be understood that no additional components exist between the above-described components.

Terms used in the present invention are used solely to describe the particular embodiments and not to limit the present invention. The singular form is intended to also include the plural form, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Unless otherwise defined, all terms including technical or scientific terms used in the present invention have meanings the same as those of terms generally understood by those skilled in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments will be described in detail with reference to the accompanying drawings, the same reference numerals are applied to the same or corresponding components regardless of the drawing numerals, and overlapping descriptions will be omitted.

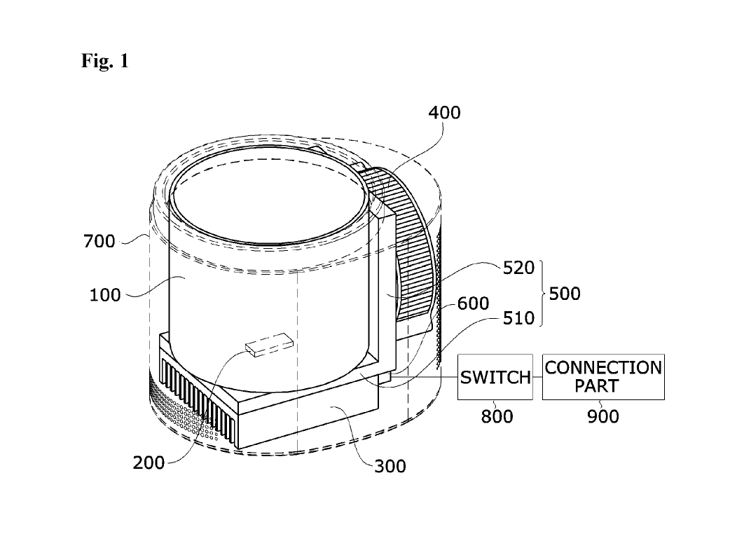

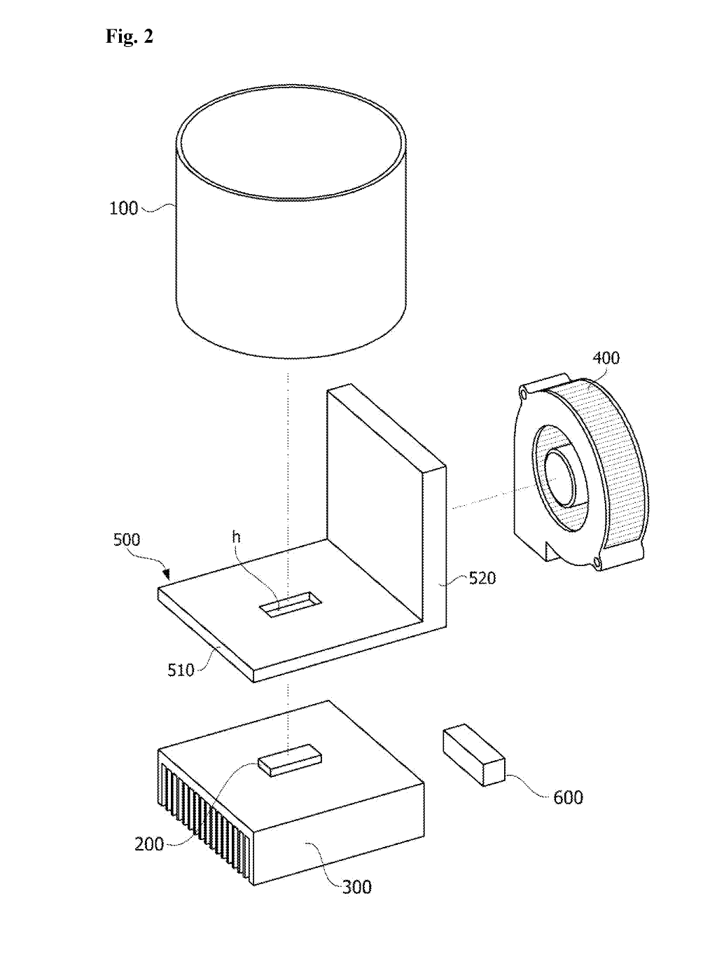

FIG. 1 is a view illustrating a cup holder according to an embodiment of the present invention, and FIG. 2 is an exploded perspective view of the cup holder according to the embodiment of the present invention.

In the embodiment, a cup holder 10 may accommodate a container therein and provide a heating and cooling function to the accommodated container, and includes a holder body 100, a thermoelectric element 200, a heat sink 300, a fan 400, a guide part 500, a power module 600, a housing 700, a switch 800, and a connection part 900.

The holder body 100 has a center part having a hollow shape and includes an accommodation part therein. Further, a cup used for a user for drinking or a container configured to accommodate liquid, such as beverages or the like, may be mounted in the accommodation part. In addition, the holder body 100 may include a metal material, an alloy material, and a synthetic resin material having great heat transference efficiency so that heating and cooling effects may be provided to the cup mounted in the holder body 100 or beverages.

In addition, the holder body 100 may have a cylindrical structure having curvature, and a lower part of the holder body 100 may have a flat plate-shaped area the thermoelectric element 200 may be mounted.

The thermoelectric element 200 may be provided under the holder body 100, and a heat generation part or a heat absorption part of the thermoelectric element 200 may be disposed to be in contact with a lower surface of the holder body 100. Thermal grease may be provided between the thermoelectric element 200 and the lower part of the holder body 100 to improve the characteristics of thermoelectric efficiency.

In the thermoelectric element 200, a part in which the thermoelectric element 200 and the lower surface of the holder body 100 are in contact with each other may become the heat generation part or the heat absorption part according to polarity of power supplied to the thermoelectric element 200. Accordingly, both the cooling effect and the heat generation effect may be provided to the container accommodated in the holder body 100.

Further, when the thermoelectric element 200, which is a heat source, is disposed on a side surface of the holder body 100, the heat source is difficult to transfer to a part distant from a part at which the thermoelectric element 200 is disposed. According to the embodiment of the present invention, since the thermoelectric element 200 is provided under the holder body 100, the heat source generated from the thermoelectric element 200 may be uniformly provided to the whole parts of the holder body 100. Further, when heat generation is performed at the lower surface of the holder body 100, heat transference to the liquid in the container accommodated in the holder body 100 is further improved in terms of heat convection.

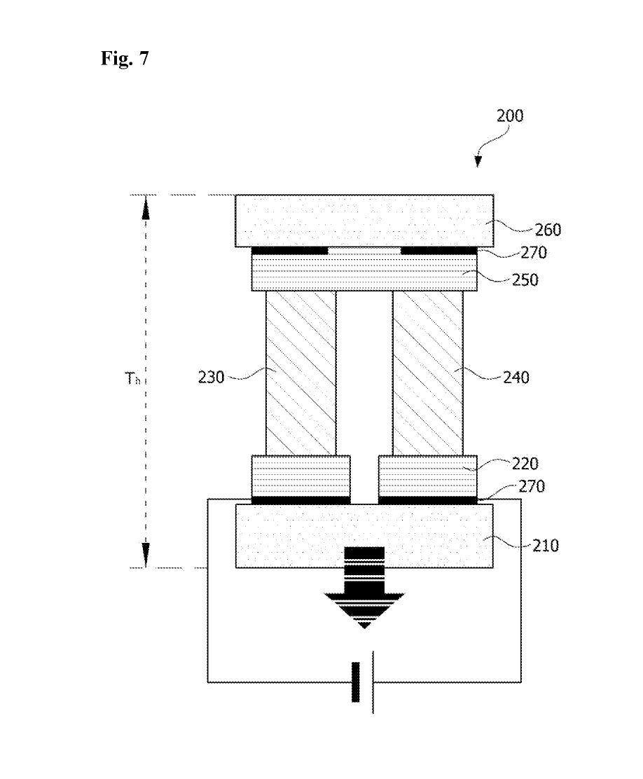

In addition, a structure of the thermoelectric element 200 or the like may be described with reference to the following, FIG. 7.

The heat sink 300 is provided on a lower surface of the thermoelectric element 200 and exchanges heat transferred from the thermoelectric element 200 with surrounding air. The heat sink 300 is disposed to be spaced apart from a flat base and includes a plurality of protruding fins 310.

The plurality of fins 310 include a metal material having excellent heat conduction and heat dissipation properties and, as one embodiment, include an aluminum material. Further, the plurality of fins 310 may be disposed to be spaced from each other to form predetermined intervals. In addition, the plurality of fins 310 may be disposed in parallel.

Air may flow between the plurality of fins 310 which are disposed in parallel in the heat sink 300, and a flow path, through which the air flows, may be formed in a direction which is the same as a direction in which the air is discharged. Accordingly, the air is smoothly moved in the heat sink 300, and heat-exchange is performed efficiently.

The fan 400 is provided on a side surface of the holder body 100 to perform suction and discharge of the air and promote the heat-exchange in the heat sink 300. That is, the air may be suctioned from one surface of the holder body 100 due to the suction and discharge of the air from the fan 400, and the suctioned air may be discharged to the lower part of the holder body 100 through the heat sink 300 of the cup holder 10. Accordingly, the fan 400 serves to induce the air to the heat sink 300 and allow the air to circulate in an apparatus.

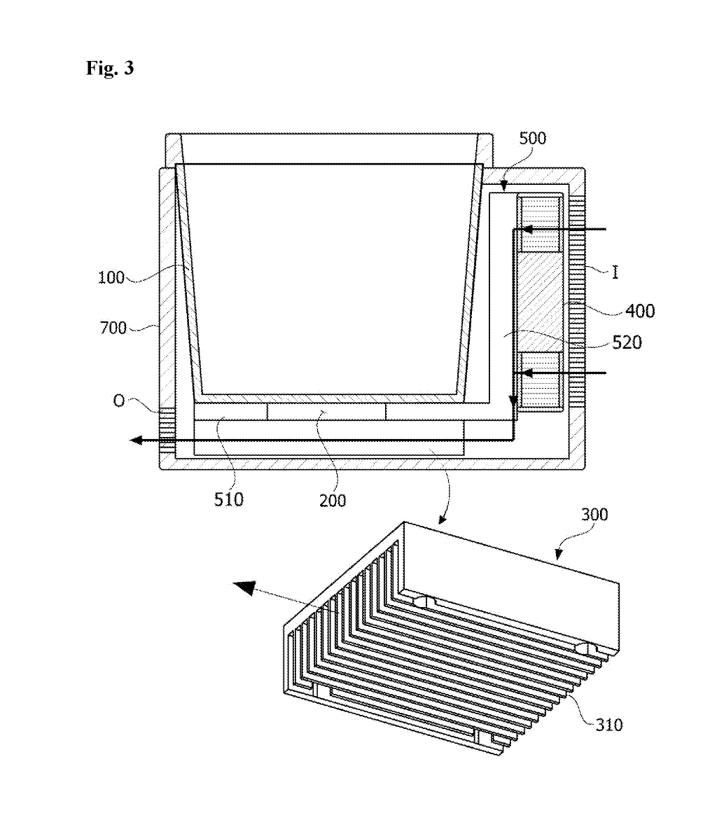

Referring to FIG. 3, which is a cross-sectional view of the cup holder according to the embodiment of the present invention and an enlarged view of the heat sink, the air, which is introduced through the fan 400 provided on the side surface of the holder body 100 in the cup holder 10, flows to the lower surface of the holder body 100 on which the heat sink 300 is disposed and is discharged to a discharge port O formed in another side surface of the holder body 100 along spaces formed between the plurality of fins 310 due to continuously introduced air.

Further, since the fan 400 and the thermoelectric element 200 (including the heat sink 300) have different disposition locations, the entire size of the cup holder 10 may be reduced more than that in a case in which the thermoelectric element 200 and the fan 400 are integrally disposed to be in close contact with each other. Accordingly, the cup holder 10 according to the embodiment may be compactly manufactured.

Referring to FIG. 6, which is a view illustrating the various fans according to the embodiment of the present invention, an air suction direction and an air discharge direction of a fan 400-1 may be the same (see FIG. 6A). Further, an air suction direction and an air discharge direction of a fan 400-2 may be different and may form a predetermined angle (see FIG. 6B).

Referring to FIG. 6B, the fan may be a blower fan 400-2, and the air suction direction and the air discharge direction at the fan 400-2 may be perpendicular to each other. Accordingly, the air suctioned from the side surface of the holder body 100 may be directly discharged to a lower part of the cup holder at which the heat sink is located. Accordingly, since air which collides with the holder body 100 is decreased, backflow of the air may be prevented, and since the suctioned air is smoothly discharged to the discharge port, heat-exchange promotion through the heat sink 300 may be improved.

The guide part 500 is provided to guide the suctioned air to the heat sink 300 through the fan 400 and support the holder body 100, and includes a first member 510 and a second member 520.

The first member 510 is disposed between the holder body 100 and the heat sink 300 and includes a hole h. The thermoelectric element 200 is disposed in the hole h so that the first member 510 surrounds the thermoelectric element 200. Accordingly, the first member supports the holder body 100 and prevents transference of the air suctioned from the outside through the air fan 400 to the holder body 100. Accordingly, thermal equilibrium of the holder body 100 may be prevented by the air suctioned from the outside.

The second member 520 includes an air flow path disposed between the holder body 100 and the fan 400 and configured to guide the air suctioned from the fan 400 to the heat sink 300.

The second member 520 may be disposed on the side surface of the holder body 100 and formed to surround the side surface of the holder body 100 to prevent transference of the air introduced from the fan 400 to the holder body 100.

Further, the second member 520 is formed to guide a flow path of the air so that the air suctioned from the fan 400 flows to the heat sink 300. As one embodiment, the second member 520 may be formed to be inclined toward the heat sink 300.

Further, the second member 520 may form an accommodation part on which the fan 400 may be mounted and may be formed to change an air flow so that the suctioned air may flow to the heat sink 300 under the cup holder 10. For example, the fan 400 may be formed so that an air suction direction and an air discharge direction may be different. Accordingly, the thermal equilibrium of the holder body 100 may be prevented by the air suctioned from the outside through the second member 520. Further, since the air suctioned through the fan 400 flows through the heat sink 300 without leakage to the outside and a flow of the air becomes smooth, efficient heat-exchange may be performed in the heat sink 300.

In addition, the second member 520 may be located on an end portion or one end of the first member 510, and the first member 510 and the second member 520 may be an integrally coupled shape.

The power module 600 is provided to supply the power to the thermoelectric element 200 and the fan 400, and may control polarity of the power supplied to the thermoelectric element 200 to heat or cool the holder body 100. Further, as one embodiment, an electric wire connected between the power module 600 and one of an external power and the switch 800 may be two electric wires. Further, the power module 600 may be connected to each of the fan 400 and the thermoelectric element 200 through two electric wires. In addition, the power module 600 may be disposed at the inside or the outside of the cup holder 10. In addition, although the power module is exemplified to be disposed at the inside of the cup holder 10, the present invention is not limited thereto.

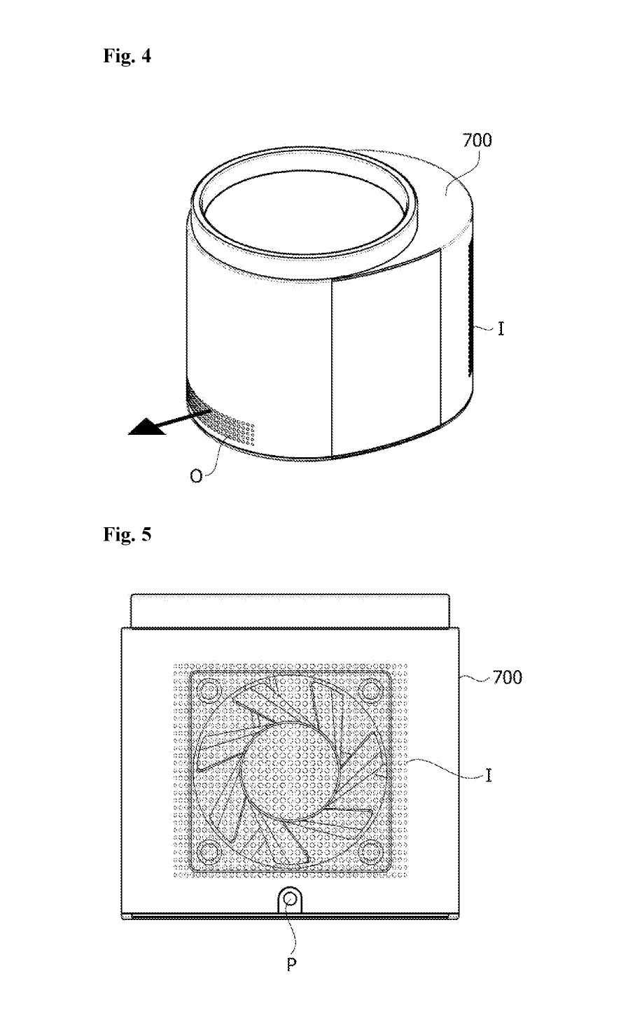

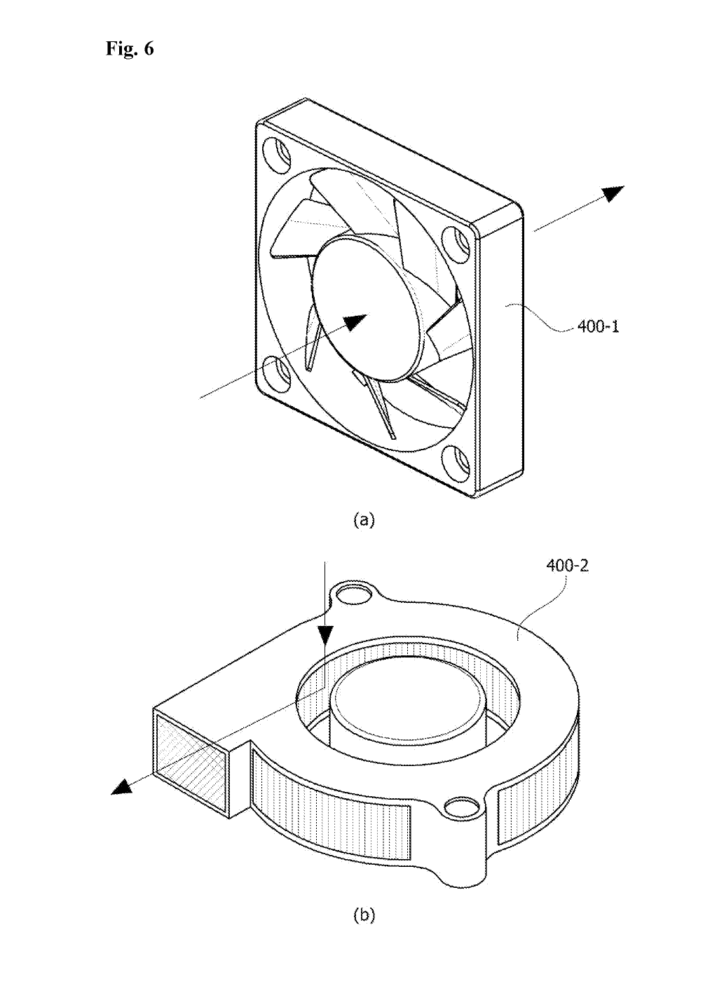

The housing 700 is an outer surface of the cup holder 10 configured to surround the holder body 100, the thermoelectric element 200, the heat sink 300, the fan 400, the guide part 500, and the power module 600. Referring to FIGS. 4 and 5, a suction port I through which the air is suctioned is formed in a side surface of the housing 700. The suction port I is formed to correspond to the location of the fan 400 disposed in the housing 700 and the air suction direction so as to smoothly suction the air. As one embodiment, the suction port I may include a plurality of holes and be formed to have an area the same as that of the fan 400.

Further, the discharge port O is formed in one side surface of the holder body 100 in a direction in which the air flows through the plurality of fins 310, and, accordingly, the air may be smoothly discharged to the outside. In addition, as one embodiment, the discharge port O may include a plurality of holes, and the plurality of holes may be formed in various shapes.

As one embodiment, the discharge port O may be formed to correspond to a shape between the plurality of fins 310 of the heat sink 300 through which the air flows.

Further, the housing 700 is disposed at the outer surface of the cup holder 10 so that the air introduced into the suction port I flows through the heat sink 300, and the housing 700 surrounds and seals the holder body 100, the fan 400, the thermoelectric element 200, and the heat sink 300 so that the air is discharged to only the suction port I and the discharge port.

In addition, an electric wire hole P connected to the power may be formed in one side surface of the housing 700.

The switch 800 may be connected to the power module 600 and disposed at the inside or the outside of the cup holder 10. In addition, the switch 800 may transmit a control signal to the power module 600 according to a selection of the user to heat or cool the holder body 100.

The connection part 900 is a connection part 900 connected to the external power and may have various shapes. As one embodiment, the connection part 900 may be formed as Universal Serial Bus (USB) power to easily supply power at any place.

As described above, the cup holder may be provided at various places or spots such as a chair of a vehicle or a theater, an accommodation space for beverages at a council board of a conference room, and the like. Further, since the cup holder may be provided as a separably detachable structure to improve user convenience and may be formed to be coupled to containers having various sizes, a conventional cup holder may be easily mounted. In addition, since an insertion diameter of the container is implemented to be variable, versatility may be demonstrated.

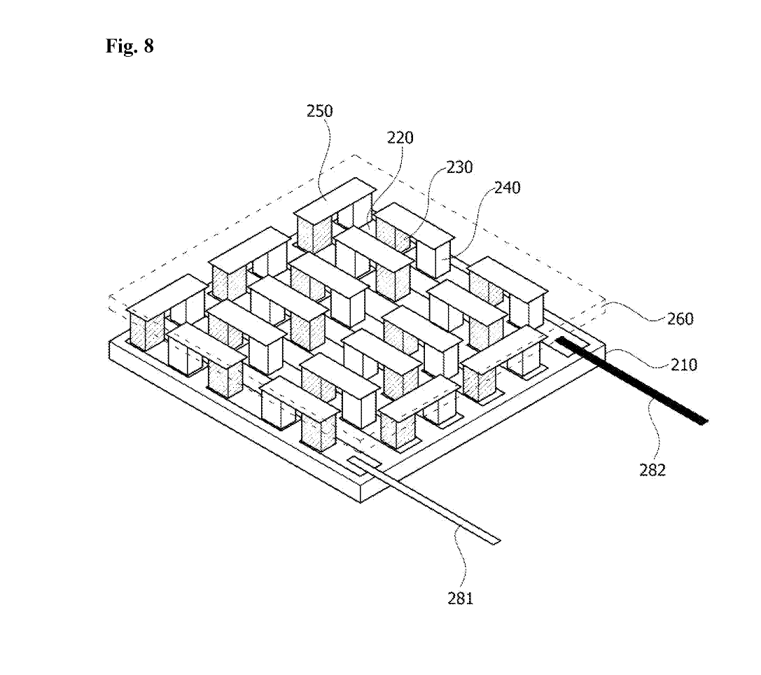

Referring to FIG. 7, which is a cross-sectional view of the thermoelectric element according to the embodiment of the present invention, and FIG. 8, which is a perspective view of the thermoelectric element according to the embodiment of the present invention, the thermoelectric element 200 includes a lower substrate 210, a lower electrode 220, a P-type thermoelectric leg 230, an N-type thermoelectric leg 240, an upper electrode 250, and an upper substrate 260.

A thermoelectric phenomenon is a phenomenon which occurs due to movement of an electron and a hole in a material and refers to direct energy conversion between heat and electricity.

The thermoelectric element is a general term for elements using the thermoelectric phenomenon and has a structure in which a P-type thermoelectric material and an N-type thermoelectric material are bonded between metal electrodes to form a PN junction pair.

The thermoelectric element may be classified into an element using temperature variation of an electric resistance, an element using a Seebeck effect, which is a phenomenon in which an electromotive force is generated due to a temperature difference, an element using a Peltier effect, which is a phenomenon in which heat absorption or heat generation due to a current occurs, or the like.

The lower electrode 220 is disposed between the lower substrate 210 and lower bottom surfaces of the P-type thermoelectric leg 230 and the N-type thermoelectric leg 240, and the upper electrode 250 is disposed between the upper substrate 260 and upper bottom surfaces of the P-type thermoelectric leg 230 and the N-type thermoelectric leg 240. Accordingly, a plurality of P-type thermoelectric legs 230 and a plurality of N-type thermoelectric legs 240 are electrically connected to each other by the lower electrode 220 and the upper electrode 250. A pair of P-type thermoelectric leg 230 and N-type thermoelectric leg 240 disposed between the lower electrode 220 and the upper electrode 250 and electrically connected to each other may form a unit cell.

For example, when a voltage is applied to the lower electrode 220 and the upper electrode 250 through lead wires 281 and 282, due to the Peltier effect, a substrate in which a current flows from the P-type thermoelectric leg 230 to the N-type thermoelectric leg 240 may absorb heat and serve as a cooling part, and a substrate in which a current flows from the N-type thermoelectric leg 240 to the P-type thermoelectric leg 230 may be heated and serve as a heat generation part.

Here, the P-type thermoelectric leg 230 and the N-type thermoelectric leg 240 may be formed of bismuth telluride (Bi-Te)-based thermoelectric legs including bismuth (Bi) and tellurium (Ti) as main materials. The P-type thermoelectric leg 230 may be a thermoelectric leg including 99 to 99.999 wt % of a bismuth telluride (Bi-Te)-based main material including at least one of stibium (Sb), nickel (Ni), aluminum (Al), copper (Cu), silver (Ag), lead (Pb), boron (B), gallium (Ga), tellurium (Te), bismuth (Bi), and indium (In), and 0.001 to 1 wt % of a compound including Bi or Te on the basis of the total weight 100 wt %. For example, the P-type thermoelectric leg 230 may include Bi-Se-Te as a main material and may further include Bi or Te in an amount of 0.001 to 1 wt % of the total weight. The N-type thermoelectric leg 240 may be a thermoelectric leg including 99 to 99.999 wt % of a bismuth telluride (Bi-Te) main material including at least one of selenium (Se), nickel (Ni), aluminum (Al), copper (Cu), silver (Ag), lead (Pb), boron (B), gallium (Ga), tellurium (Te), bismuth (Bi), and indium (In), and 0.001 to 1 wt % of a compound including Bi or Te on the basis of the total weight 100 wt %. For example, the N-type thermoelectric leg 240 may include Bi-Sb-Te as a main material, and may further include Bi or Te in an amount of 0.001 to 1 wt % of the total weight.

Each of the P-type thermoelectric leg 230 and the N-type thermoelectric leg 240 may be formed as a bulk type or a lamination type. Generally, the bulk type P-type thermoelectric leg 230 or the bulk type N-type thermoelectric leg 240 may be acquired through a process of heat-treating a thermoelectric material to manufacture an ingot, acquiring a powder for the thermoelectric leg by grinding and straining the ingot, and then sintering the powder and cutting a sintered body. The lamination type P-type thermoelectric leg 230 or the lamination type N-type thermoelectric leg 240 may be acquired through a process of forming a unit member by applying paste including a thermoelectric material on a sheet-shaped base material, and then laminating and cutting the unit member.

In this case, a pair of thermoelectric legs including the P-type thermoelectric leg 230 and N-type thermoelectric leg 240 may have the same shape and volume, or different shapes and volumes. For example, since conductive characteristics of the P-type thermoelectric leg 230 and the N-type thermoelectric leg 240 are different, a height or cross-sectional area of the N-type thermoelectric leg 240 may be formed to be different from that of the P-type thermoelectric leg 230.

The performance of the thermoelectric element according to the embodiment of the present invention may be shown as a Seebeck index. The Seebeck index (ZT) may be expressed by Equation 1.

ZT=α²·σ·T|K Equation 1

Here, α is a Seebeck coefficient [V/K], σ is electrical conductivity [S/m], and α² σ is a power factor, [W/mK²]). Further, T is a temperature, and k is thermal conductivity [W/mK].

k may be expressed as a·cₚ·ρ, a is thermal diffusivity [cm²/S], cₚ is specific heat [J/gK], and ρ is density [g/cm³].

In order to acquire the Seebeck index of the thermoelectric element, a Z value (V/K) may be measured using a Z meter, and the Seebeck index (ZT) may be calculated using the measured Z value.

Here, each of the lower electrode 220, which is disposed between the lower substrate 210 and the P-type thermoelectric leg 230 and the N-type thermoelectric leg 240, and the upper electrode 250, which is disposed between the upper substrate 260 and the P-type thermoelectric leg 230 and the N-type thermoelectric leg 240, may include at least one of copper (Cu), silver (Ag), and nickel (Ni) and have a thickness of 0.01 mm to 0.3 mm. When the thickness of the lower electrode 220 or the upper electrode 250 is smaller than 0.01 mm, a function thereof as an electrode may be lowered and thus an electricity conductivity performance may be lowered, and when the thickness is greater than 0.3 mm, a resistance may increase and thus conductivity efficiency may be lowered.

Further, the lower substrate 210 and the upper substrate 260 which face each other may be insulating substrates or metal substrates. The insulating substrate may be an alumina substrate or a flexible polymer resin substrate. The flexible polymer resin substrate may include various insulating resin materials such as polyimide (PI), polystyrene (PS), polymethyl methacrylate (PMMA), cyclic olefin copolymer (COC), polyethylene terephthalate (PET), high transmissive plastic such as resin, and the like. The metal substrate may include Cu, a Cu alloy, or a Cu-Al alloy and may have a thickness of 0.1 mm to 0.5 mm. When the thickness of the metal substrate is smaller than 0.1 mm or greater than 0.5 mm, since a heat dissipation characteristic or thermal conductivity may excessively increase, reliability of the thermoelectric element may be lowered. Further, when the lower substrate 210 and the upper substrate 260 are the metal substrates, dielectric layers 270 may be further formed between the lower substrate 210 and the lower electrode 220 and between the upper substrate 260 and the upper electrode 250. The dielectric layer 270 includes a material having a heat conductivity of 5˜10 W/K and may be formed to have a thickness of 0.01 mm to 0.15 mm. When the thickness of the dielectric layer 270 is smaller than 0.01 mm, insulation efficiency or a withstand voltage characteristic may be lowered, and when the thickness is greater than 0.15 mm, the thermoelectric conductivity is lowered and thus heat dissipation efficiency may be lowered.

In this case, the lower substrate 210 and the upper substrate 260 may be different sizes. For example, a volume, a thickness, or an area of one of the lower substrate 210 and the upper substrate 260 may be formed to be greater than that of the other one. Accordingly, heat absorption performance or heat dissipation performance of the thermoelectric element may be improved.

Further, a heat dissipation pattern, for example, an uneven pattern, may be formed in a surface of at least one of the lower substrate 210 and the upper substrate 260. Accordingly, the heat dissipation performance of the thermoelectric element may be improved. When the uneven pattern is formed in a surface which is in contact with the P-type thermoelectric leg 230 or the N-type thermoelectric leg 240, the junction characteristics between the thermoelectric leg and the substrate may be improved.

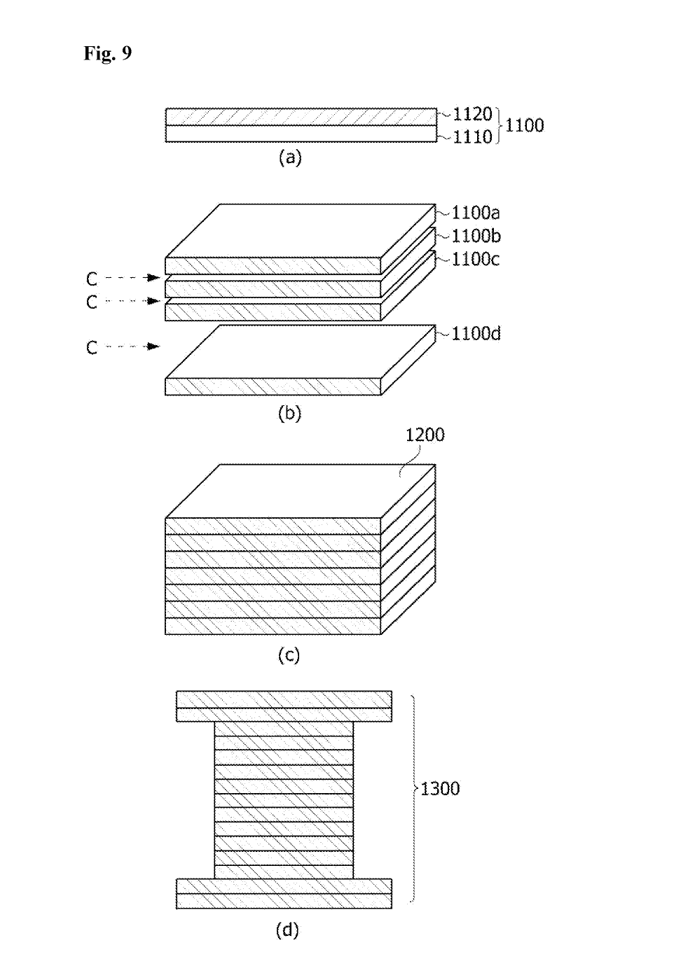

FIG. 9 is a view illustrating a method of manufacturing thermoelectric legs having a lamination structure. Referring to FIG. 9, a material including a semiconductor material is manufactured in a paste type and then applied on a base material 1110 such as a sheet, a film, or the like to form a semiconductor layer 1120. Accordingly, one unit member 1100 may be formed.

A plurality of unit members 1100a, 1100b, and 1100c may be laminated to form a lamination structure 1200, and a unit thermoelectric leg 1300 may be acquired by cutting the lamination structure 1200.

Like the above, the unit thermoelectric leg 1300 may be formed by a structure in which the plurality of unit members 1100, each having the semiconductor layer 1120 formed on the base material 1110, are laminated.

Here, the process of applying the paste on the base material 1110 may be performed by various methods. For example, the process of applying the paste on the base material 1110 may be performed by a tape casting method. The tape casting method is a method of mixing a fine semiconductor powder with at least one of an aqueous or nonaqueous solvent, a binder, a plasticizer, a dispersant, a defoamer, and a surfactant to manufacture in a slurry type and then molding on a moving blade or a moving base material. In this case, the base material 1110 may be a film, a sheet, or the like having a thickness of 10 um to 100 um, and the P-type thermoelectric material or the N-type thermoelectric material which manufactures the above-described bulk-type element may be applied, intact, as a semiconductor material which is applied.

A process of aligning and laminating the unit member 1100 as a plurality of layers may be performed by a method of pressing at a temperature of 50 to 250° C., and the number of laminated unit members 1100, may be, for example, two to fifty. Further, the unit member 1100 may be cut in a desired shape and a desired size, and a sintering process may be added.

Like the above, the manufactured unit thermoelectric leg 1300 may secure uniformity of a thickness, a shape, and a size thereof, may be advantageous for being thinned, and may reduce loss of a material.

The unit thermoelectric leg 1300 may have a cylindrical shape, a polygonal pillar shape, an ellipse pillar shape, or the like, and may be cut in a shape shown in FIG. 9D.

Meanwhile, a conductive layer may be further formed on one surface of the unit member 1100 to manufacture the thermoelectric leg having a lamination structure.

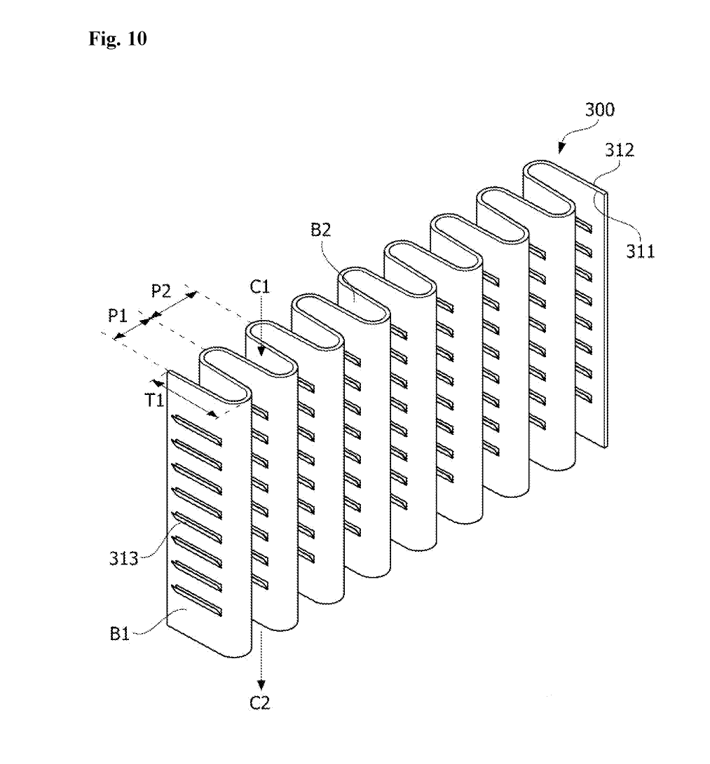

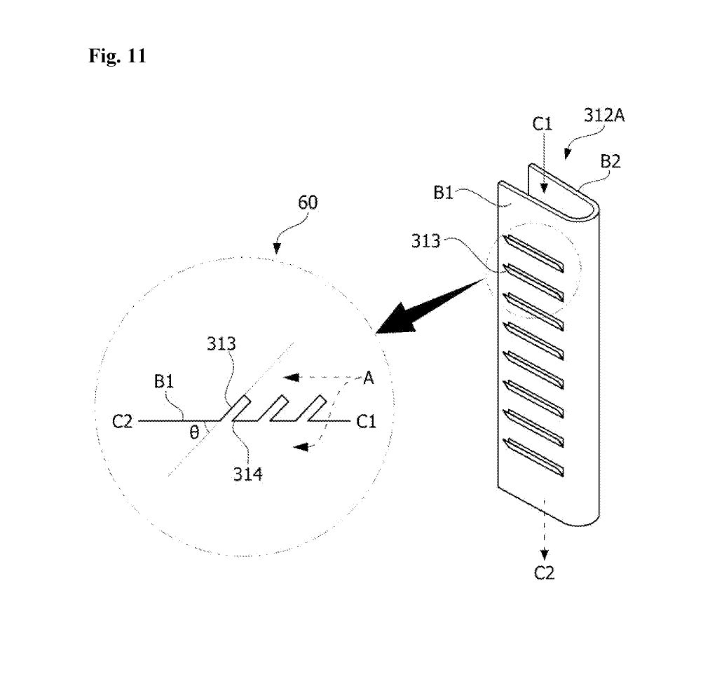

FIGS. 10 to 12 are conceptual diagrams of the heat sink according to the embodiment of the present invention. Referring to FIGS. 10 to 12, the heat sink 300 according to the embodiment of the present invention is a flat plate-shaped base material having a first flat surface 311 and a second flat surface 312 and may include at least one flow path pattern 312A configured to form an air flow path C1.

As shown in FIGS. 10 to 12, the flow path pattern 312A may be formed in a structure which folds the base material, that is, a folded structure, to form a curvature pattern having predetermined pitches P1 and P2 and a predetermined thickness T1.

Like the above, the air may be in surface contact with the first flat surface 311 and the second flat surface 312 of the heat sink 300, and a surface with which the air comes into contact by the flow path pattern 312A may be maximized.

Referring to FIG. 10, when the air is introduced in a flow path direction C1, the air may uniformly come into contact with the first flat surface 311 and the second flat surface 312 and move to proceed in a flow path direction C2. Accordingly, since the heat sink 300 has a surface area which comes into contact with the air greater than that of a flat plate-shaped base material, an effect of heat absorption or heat generation increases.

According to the embodiment of the present invention, a protruding resistance pattern 313 may be formed on a surface of the base material to further increase an air contact area.

Further, as shown in FIG. 11, the resistance pattern 313 may be formed as a protruding structure inclined to have a predetermined inclination angle θ in a direction in which the air is introduced. Accordingly, since friction between the resistance pattern 313 and the air may be maximized, a contact area or contact efficiency may increase. Further, grooves 314 may be formed in a base material surface of a front portion of the resistance pattern 313. Since some of the air which comes into contact with the resistance pattern 313 moves between a front surface and a rear surface of the base material by passing through the grooves 314, the contact area or the contact efficiency may further increase.

The resistance pattern 313 is shown to be formed in the first flat surface 311 but is not limited thereto and may also be formed in the second flat surface 312.

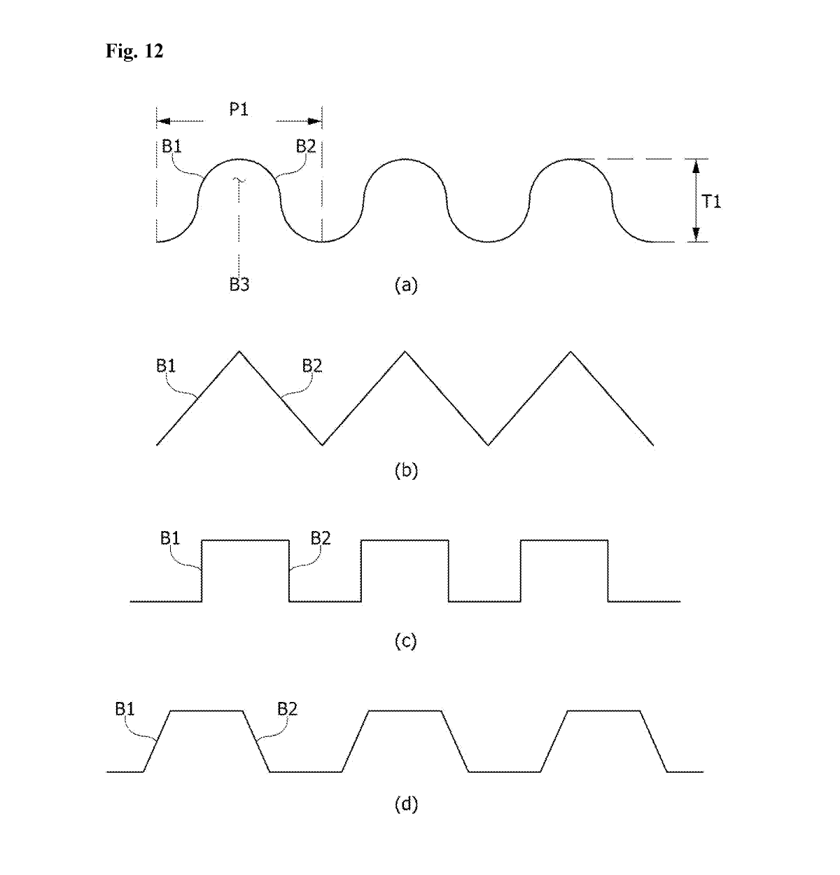

Referring to FIG. 12, the flow path pattern may have various modifications.

For example, patterns having curvature at a predetermined pitch P1 may be repetitively formed as shown in FIG. 12A, patterns having sharp parts may be repetitively formed as shown in FIG. 12B, and the unit pattern may have a polygonal structure as shown in FIGS. 12C and 12D. Although not shown, the resistance pattern may also be formed in surfaces B1 and B2 of the pattern.

The flow path pattern has a predetermined period and a predetermined height in FIG. 12, but the present invention is not limited thereto, and the period and the height T1 of the flow path pattern may be nonuniformly changed.

Although the present invention is described in the above with reference to a preferable embodiment of the present invention, the present invention may be understood to be variously changed and modified by those skilled within the spirit and the scope of the present invention disclosed in the below-described claims.

1. A cup holder comprising:
a holder body;
a thermoelectric element disposed under the holder body;
a heat sink disposed under the thermoelectric element;
a fan disposed at a side surface of the holder body and configured to discharge air suctioned from the side surface of the holder body through the heat sink;
a first member disposed between the holder body and the heat sink and including a hole; and
a second member disposed between the holder body and the fan and including an air flow path configured to guide the suctioned air.

2. The cup holder of claim 1, wherein the heat sink includes a plurality of fins disposed to be spaced apart from each other in a direction the same as a direction in which the air is discharged.

3. The cup holder of claim 2, wherein the plurality of fins are disposed in parallel.

4. The cup holder of claim 1, wherein the second member is disposed to surround the holder body.

5. The cup holder of claim 1, wherein the thermoelectric element is disposed in the hole.

6. The cup holder of claim 1, wherein the air flow path is formed such that the suctioned air passes the heat sink.

7. The cup holder of claim 1, wherein the fan discharges the air in a direction different from a direction in which the air is suctioned.

8. The cup holder of claim 1, wherein the fan includes a blower fan.

9. The cup holder of claim 1, further comprising a housing configured to surround outer surfaces of the heat sink and the fan.

10. The cup holder of claim 9, wherein the housing includes a suction port into which the air is suctioned from the fan and a discharge port through which the suctioned air is discharged.

11. The cup holder of claim 10, wherein the suction port is disposed to correspond to the fan.

12. The cup holder of claim 10, wherein:
the heat sink includes a base and a plurality of fins disposed on the base and disposed to be spaced apart from each other in a direction the same as a direction in which the air is discharged; and
the discharge port is disposed to correspond to spaces between the plurality of fins.

13. The cup holder of claim 12, wherein the plurality of fins include a metal material.

14. The cup holder of claim 12, wherein the plurality of fins are disposed in parallel.

15. The cup holder of claim 1, wherein the second member is disposed to be inclined toward the heat sink.

16. The cup holder of claim 1, wherein the second member is disposed on an end portion or one end of the first member.

17. The cup holder of claim 1, wherein the second member is disposed to surround the side surface of the holder body.

18. The cup holder of claim 1, wherein the second member includes an accommodation part on which the fan is disposed.

19. The cup holder of claim 1, further comprising:
a power module configured to supply power to the thermoelectric element and the fan; and
a switch configured to control polarity of the power supplied to the thermoelectric element.

20. The cup holder of claim 1, wherein the first member and the second member are integrally coupled.
